(19) United States
(12) Patent Application Publication
(10) Pub. No.: US 2002/0085155 A1
(43) Pub. Date: Jul. 4, 2002

(54) Liquid crystal display device and electronic apparatus provided with the same

(76) Inventor: Yasuo Arikawa, Chino-shi (JP)

Correspondence Address: EPSON RESEARCH AND DEVELOPMENT INC, INTELLECTUAL PROPERTY DEPT, 150 RIVER OAKS PARKWAY, SUITE 225, SAN JOSE, CA, 95134, US

(21) Appl. No.: 10/015,207

(22) Filed: Nov. 19, 2001

(30) Foreign Application Priority Data
Nov. 22, 2000 (JP) 2000-355948
Sep. 4, 2001 (JP) 2001-267913

(51) Int. Cl. G02F 1/1337

(52) U.S. Cl. 349/129

(57) ABSTRACT

A liquid crystal panel has window portions at positions corresponding to pixels and a light modulator provided with a light modulation portion at a position corresponding to non-pixel-display portions. An electric field is not applied to pixels needed for forming a desired display pattern such, as a numeral. The pixels not receiving the electric field produce a bright image. An electric field is applied to pixels are not part of the desired display pattern. Pixels that to which the electric field is applied whereby a display mode of reverse display (negative pattern) can be realized.

### BACKGROUND OF THE INVENTION

1. Field of the Invention

The present invention relates to the structures of display devices for realizing predetermined viewing modes, and more specifically, relates to a liquid crystal display device and an electronic apparatus provided with the same.

2. Description of the Related Art

In liquid crystal display devices for use in word processors, electronic calculators, and the like, display of a so-called positive pattern is generally performed. For example, the background is displayed in a bright color (a light color, such as white, light green, light gray, or silver), and a display pattern such as numerals or letters is displayed in a dark color (a deep color such as black). However, in a liquid crystal display device for use in products which must have a stylish appearance, for example, a watch, relatively many displays of negative patterns have been performed in which the background is displayed in a dark color, and a display pattern, such as numerals or letters, is displayed in a bright color.

When the display of positive pattern described above is performed, a so-called normally white liquid crystal panel has been generally used which has a pair of polarizers provided at both sides of a TN mode liquid crystal cell in a cross nicol relation (that is, the polorizers' transmission axes are perpendicular to each other). In this normally white liquid crystal display device, when an electric field is not applied, the pixel exhibits a bright color since the light transmittance is high, and when an electric field is applied, the pixel exhibits a dark color since the light transmittance is decreased.

In contrast, in the case in which the display of negative pattern is performed, the normally white liquid crystal panel described above may also be used; however, when an area (segment portion) at which pixels are formed is limited to a part of the display area, for example, when digital display is performed on a watch, a normally black liquid crystal panel has been frequently used. The normally black liquid crystal panel described above is a reverse type liquid crystal panel which exhibits a dark color when an electric field is not applied since the light transmittance is low, and exhibits a bright color when an electric field is applied since the light transmittance is increased.

When the display of negative pattern described above is performed, it is necessary to produce a bright color by applying an electric field to pixels which form a display pattern, such as numerals or letters. However, as can be seen in the graph in FIG. 9, which shows the relationship between the percent of light transmittance corresponding to an applied voltage, a sufficiently high voltage can initially not be applied due to the start-up conditions affecting amount of light transmittance per applied voltage. Therefore, , the luminosity of the display pattern cannot be increased to a desired degree, and the display contrast is decreased resulting in a degradation problem of the display quality.

In addition, the viewing angle property is also not very good, and hence, a problem in that the visibility is degraded also occurs.

### OBJECTS OF THE INVENTION

Accordingly, the present invention was made to solve the problems described above, and an object of the present invention is to provide a liquid crystal display device which is preferably used for displaying negative patterns, can be formed at a reduced cost, and has a superior display quality.

### SUMMARY OF THE INVENTION

A liquid crystal display device of the present invention for solving the problems described above includes a liquid crystal panel having a pixel and a light modulation means having a first area provided with a predetermined light modulation property at a position approximately corresponding to the pixel location and a second area provided with a light modulation property at a position other than that of the first area, wherein the light modulation property of the second area is different from that of the first area. Alternatively, the first area may be provided without the predetermined light modulation property.

According to the present invention, when the light modulation means includes the first area at the position approximately corresponding to the pixel and the second area at the positions other than that of the first area, a predetermined viewing mode can be realized due to the property of the first area when the light transmittance of the pixel is increased. Furthermore, when the light transmittance of the pixel is decreased, another display mode may be realized. In addition, a display mode in accordance with the property of the second area is realized in the second area. Accordingly, when the properties of the first area and the second area of the light modulation means are properly set, a display can be achieved in accordance with the properties of the light modulation means. For example, even when a so-called normally white liquid crystal panel is used, the display of a negative pattern can be achieved by properly setting the optical property of the first area and the light modulation property of the second area.

In the light modulation means described above, the first area may have a predetermined light modulation property. On the other hand, the second area is formed so as to perform at least some light modulation for light, and the light modulation mode of the second area is different from that of the first area. For example, since the first area may be formed so as to exhibit a bright display, and the second area may be formed so as to exhibit a dark display. In so doing, a display of a so-called negative pattern can be realized. Alternatively, the first area may not perform light modulation at all.

The light modulation function or the light modulation property of the light modulation means includes frequency modulation which can change the hue, amplitude modulation which can change the brightness, and phase modulation which can change the color quality. When the light modulation means is provided with at least one of the frequency modulation, amplitude modulation, and phase modulation described above, that is, when the light modulation means is provided with one of the modulation functions described above or at least two thereof appropriately combined with each other, various hues, brightness, color quality, or the like can be created.

In the present invention, the second area is preferably provided at a position corresponding to that at in which the pixel is not provided. That is, the first and second areas do not overlap. When the second area is provided at a background portion (portion where the display pattern cannot be formed) at which the pixel is not provided, a display mode of a so-called background portion of an electronic calculator or a watch can be created by using the light modulation property of the second area.

In the present invention, the liquid crystal panel described above is preferably formed so that the first viewing mode or the second viewing mode, which are different from each other, is selectively performed in the pixel in accordance with an application state of a voltage by using light which is modulated, or alternatively not modulated, in the first area.

In the present invention, it is preferable that the first viewing mode be visually nearer to a third viewing mode which is obtained by using light modulation in the second area, and that the second viewing mode be visually further from the third viewing mode. Since the first viewing mode realized in the pixel is visually nearer to the third viewing mode (for example, both are a dark display) obtained by using the light modulated in the second area, when the first viewing mode is realized, the pixel may be placed in a non-display state (for example, dark display). In addition, since the second viewing mode is visually further from the third viewing mode as compared to the first viewing mode, the pixel may be placed in a display state (for example, placed in a bright display operating mode). Accordingly, a display mode can be realized in which a pixel having the second viewing mode is used as a display pattern, and a pixel having the first viewing mode and a portion having the third viewing mode are used as the background portion. In addition, a reverse display can be formed when the display pattern is bright, and the background portion is dark.

The visual distance is the degree of difference in visibility defined by the difference in luminosity, hue (color coordinates), and the like, together with human engineering perception and knowledge. In general, the product of the difference in luminosity and the distance of a position on the hue circle defined by JIS is calculated by multiplying each parameter by an appropriate factor, whereby the visual distance can be defined.

In the present invention, the liquid crystal panel is preferably formed so that the second viewing mode is realized in the pixel when a voltage is not applied. Since the second viewing mode is realized when a voltage is not applied, when a display pattern formed, for example to display a digital representation of time using a plurality of pixels, the number of pixels to which an voltage is applied can be reduced, and hence, the electric power consumption can be reduced.

In the present invention, the second viewing mode preferably has high luminosity as compared to that of the first viewing mode. In the case described above, since the second viewing mode is bright, and the first viewing mode is dark, when the pixel defines the display pattern portion, and second area corresponds to the background portion, a reverse display (display of negative patterns) can be created. In the case described above, when the pixel is formed so as to exhibit the second viewing mode when a voltage is not applied, a liquid crystal panel can be used which is formed of a panel structure (a so-called normally white type) having a high light transmittance when a voltage is not applied. Hence, the liquid crystal panel can be easily obtained at a low cost, and the production cost can be reduced. In addition, the display quality can be improved, for example, the luminosity of a bright portion can be increased without increasing a driving voltage, the display contrast can be improved, and a superior viewing angle property can also be obtained.

In the present invention, the second viewing mode preferably includes a plurality of viewing modes different from each other formed in a plurality of said pixels, or the second viewing mode preferably includes a plurality of viewing modes different from each other formed in the pixel. When the second viewing mode includes a plurality of view modes different from each other in the plurality of pixels, a display composed of different viewing modes between the pixels can be performed. For example, a display formed of pixels having hues different from each other can be performed, and hence, a two-color display can be created. In addition, when the plurality of second viewing modes which are different from each other is formed in one pixel, various design mode can be realized in one pixel. For example, when viewing modes having different hues are formed in one pixel, a two-color display can be created. The viewing modes different from each other are not limited to hues, and viewing modes having different luminosity or color quality may also be used.

In the present invention, the liquid crystal panel described above may comprise a liquid crystal cell which exhibits a retardation property depending on an applied electric field; a first polarization means provided at the front side of the liquid crystal cell; and a second polarization means provided at the rear side of the liquid crystal cell. In the case described above, by controlling an application state of an electric field in the pixel, when the liquid crystal cell has a certain retardation value, the liquid crystal panel can be placed in a state in which a polarization component passing through the second polarization means may pass the first polarization means while maintaining its polarized state via the liquid crystal cell, that is, the liquid crystal panel can be placed in a transmission state. On the other hand, when the liquid crystal cell has another retardation value, the liquid crystal panel can be placed in a state in which a polarization component passing through the second polarization means and the liquid crystal cell is blocked by the first polarization means, that is, the liquid crystal panel can be placed in a light blocking state.

As a liquid crystal panel to which the present invention can be applied, a known reflective liquid crystal panel provided with one piece polarizer may be used which comprises polarization means and a retardation film at the front side of the liquid crystal cell, and a reflective layer at the rear side of the liquid crystal cell. In addition, a liquid crystal panel using polymer dispersed liquid crystal or guest-host liquid crystal (including a mode in combination thereof) without using a polarizer, or a liquid crystal panel using a dynamic scattering mode may also be used.

In the present invention, the light modulation means is preferably disposed between the liquid crystal cell and the second polarization means or is preferably disposed at the rear side of the second polarization means and adjacent thereto. In the case in which a liquid crystal panel comprises two polarizers, as described above, the light modulation means may be disposed at the front side or at the rear side of the second polarization means and adjacent thereto, whereby the difference between the depth (depth at which a predetermined viewing mode can be optically viewed) of the viewing mode which is viewed due to optical properties of the liquid crystal in the pixel and the depth of the viewing mode obtained by using the light modulated in the second area of the light modulation means can be reduced, and a strange visual sensation can be suppressed. The reason for this is that since a viewing mode obtained due to the optical properties of the liquid crystal in the pixel, for example, a dark viewing mode, is optically viewed as if it is disposed at a position of the second polarization means which is provided at the rear side of the liquid crystal cell, the apparent depth of this viewing mode can be made to be approximately equivalent to the physical depth of the light modulation means.

In the present invention, the light modulation means is preferably disposed at the front side of the first polarization means or is preferably disposed between the first polarization means and the liquid crystal cell. In the case described above, the liquid crystal cell is disposed at the rear side of the light modulation means, and hence, it is not necessary for a part of the liquid crystal cell to exist at a portion (portion other than a pixel) corresponding to the second area of the light modulation means. Accordingly, when a plurality of pixels is formed, a plurality of liquid crystal cells can be disposed at the rear side of the light modulation means, and hence, a plurality of pixels can be formed by using the plurality of liquid crystal cells.

In the present invention, it is preferable that at least one of the first polarization means and the second polarization means selectively modulate a polarization component having a transmission plane in a predetermined direction to form a predetermined polarized spectral distribution of the polarization component so that a color tone obtained by this polarized spectral distribution and a modulated spectral distribution formed by light modulation or non-modulation in the first area is approximately equivalent to a color tone obtained by modulating light in the second area.

The polarization means generally used may be one which selectively absorbs (or reflects) a polarization component having a transmission plane in a predetermined direction, and substantially remove the polarization component in, for example, the visible light range. In addition to the polarization means described above, there is polarization means which modulates a polarization component so as to form a predetermined polarized spectral distribution thereof, and as an example thereof, there may be mentioned a so-called color polarizer which primarily transmits light in a specific wavelength region (for example, the red color region). When this polarized spectral distribution is formed so as to have a color tone approximately equivalent to that of the spectral distribution obtained by modulating light in the second area, and the retardation property of the liquid crystal cell is appropriately controlled by an applied voltage, a viewing mode approximately equivalent to the viewing mode in the second area, for example, the first viewing mode described above, can be realized in the pixel.

In the case described above, by controlling an application state of an electric field in a pixel, when the liquid crystal cell has a certain retardation value, the liquid crystal panel can be placed in a state in which a polarization component passing through the second polarization means may pass through the first polarization means while maintaining its polarized state via the liquid crystal cell, that is, the liquid crystal panel can be placed in a light transmission state. In addition, when the liquid crystal cell has another retardation value, the liquid crystal panel can be placed in a state in which a polarization component passing through the second polarization means and the liquid crystal cell is blocked in the first polarization means, that is, the liquid crystal panel can be placed in a light blocking state. Accordingly, when the liquid crystal panel is in a light transmission state, a certain viewing mode determined by the property of the first area of the light modulation means, for example, the second viewing mode, can be obtained in the pixel. On the other hand, when the liquid crystal panel is in a light blocking state, another viewing mode determined by both the property of the light modulation means and the polarized spectral distribution described above, for example, the first viewing mode, can be obtained in the pixel.

The latter viewing mode is generally determined by subtractive mixing of the polarized spectral distribution and a spectral distribution formed in the first area. For example, when the first area does not substantially perform light modulation (that is, transparent and colorless), the viewing mode is determined by the polarized spectral distribution. When this polarized spectral distribution has generally low intensity in the visible light range, the viewing mode is a dark color (for example, a black color), and when this polarized spectral distribution localizes in the red color region in the visible light range, the viewing mode is a red color. In addition, when the first area is formed so as to perform predetermined light modulation, a viewing mode can be obtained in accordance with the spectral distribution formed of the product (synthesis or subtractive mixing) of the polarized spectral distribution of the polarization component modulated by polarization means and a modulated spectral distribution showing the mode of light modulation in the first area. For example, when the first area forms a yellowish color (that is, light having a spectral distribution having an effective light component in the red color region and the green color region), and when the polarized spectral distribution formed by modulation using the polarization means described above localizes in the red color region and the blue color region (magenta) in the visible light range, the viewing mode is a red color by subtractive mixing of both light.

In addition, in a more particular liquid crystal display device of the present invention, the liquid crystal panel comprises a liquid crystal cell, first polarization means provided at the front side of the liquid crystal cell, and second polarization means provided at the rear side of the liquid crystal cell, and at least one of the first polarization means and the second polarization means selectively modulates a polarization component having a transmission plane in a predetermined direction to form a predetermined spectral distribution of the polarization component so as to realize the first viewing mode by the polarized spectral distribution and a modulated spectral distribution formed by modulation or non-modulation in the first area.

In the present invention, it is preferable that the first viewing mode be realized in the pixel by the product of the polarized spectral distribution obtained by modulating the polarization component using at least one of the first polarization means and the second polarization means and a modulated spectral distribution obtained by light modulation or non-modulation in the first area, and that the product of the spectral distribution described above be formed so as to be approximately equivalent to the viewing mode obtained by light modulation in the second area.

In the present invention, the second viewing mode is preferably formed in the pixel by light modulation in the first area without being modulated by at least one of the first polarization means and the second polarization means which are able to form the polarized spectral distribution. Alternatively, the second viewing mode may be formed by non-modulation of light.

In the present invention, it is preferable that a plurality of said liquid crystal panels each having the pixel be provided and that the light modulation means be provided at the front side of the plurality of said liquid crystal panels. In the case described above, since the plurality of said liquid crystal panels is provided at the rear side of the light modulation means, a large liquid crystal display device can be easily formed without forming a large liquid crystal panel. In addition, in the case described above, each liquid crystal panel may form one pixel or may form a plurality of pixels.

In addition, an electronic apparatus of the present invention is provided with the liquid crystal display device according to the present invention described above. As the electronic apparatuses, there may be mentioned various electronic apparatuses provided with liquid crystal display devices at the display portions thereof, such as various imaging apparatuses, an electronic display board, an information processing apparatus, a printing apparatus, and a mobile phone. In particular, the display surface of the liquid crystal display device of the present invention is effectively used as a time information display portion. The time information includes current time, alarm time, world time, elapsed time, remaining time (timer), and the like.

In particular, digital time information display is effectively performed by a dot matrix or a segment type liquid crystal display device, and in addition, pattern display (display of an icon representing a specific content or a specific character) can be very effectively performed together with or without the time information display. Furthermore, when the pattern display described above is performed, a representative portion such as an icon or a character may be formed of a plurality of pixels so as to move with time (performing animation movement or the like).

Other objects and attainments together with a fuller understanding of the invention will become apparent and appreciated by referring to the following description and claims taken in conjunction with the accompanying drawings.

### BRIEF DESCRIPTION OF THE DRAWINGS

In the drawings wherein like reference symbols refer to like parts.

FIG. 1 is a schematic plan view of a time information display portion of an electronic apparatus (illustratively shown as a watch) having a liquid crystal display device therein according to the present invention;

FIG. 2 is a partly enlarged plan view showing a display area R of FIG. 1;

FIG. 3 is a vertical cross-sectional view for schematically showing the structure of a first embodiment according to the present invention;

FIG. 4 is a vertical cross-sectional view for schematically showing the structure of a second embodiment according to the present invention;

FIG. 5 includes views (a) and (b) for illustrating optical behaviors in the second embodiment;

FIG. 6 is a vertical cross-sectional view for schematically showing the structure of a third embodiment according to the present invention;

FIG. 7 is a partly vertical cross-sectional view for schematically showing the structure of a fourth embodiment according to the present invention;

FIG. 8 is a partly cross-sectional view for schematically showing the state taken along the line B-B in FIG. 7;

FIG. 9 is a graph for showing the relationship between the light transmittance and the applied voltage of a TN mode liquid crystal display device; and

FIG. 10 is block diagram for showing a schematic circuit configuration of a liquid crystal display device which can be used in each embodiment.

### DESCRIPTION OF THE PREFERRED EMBODIMENTS

Hereinafter, embodiments of a liquid crystal display device and an electronic apparatus according to the present invention will be described in detail with reference to the accompanying figures.

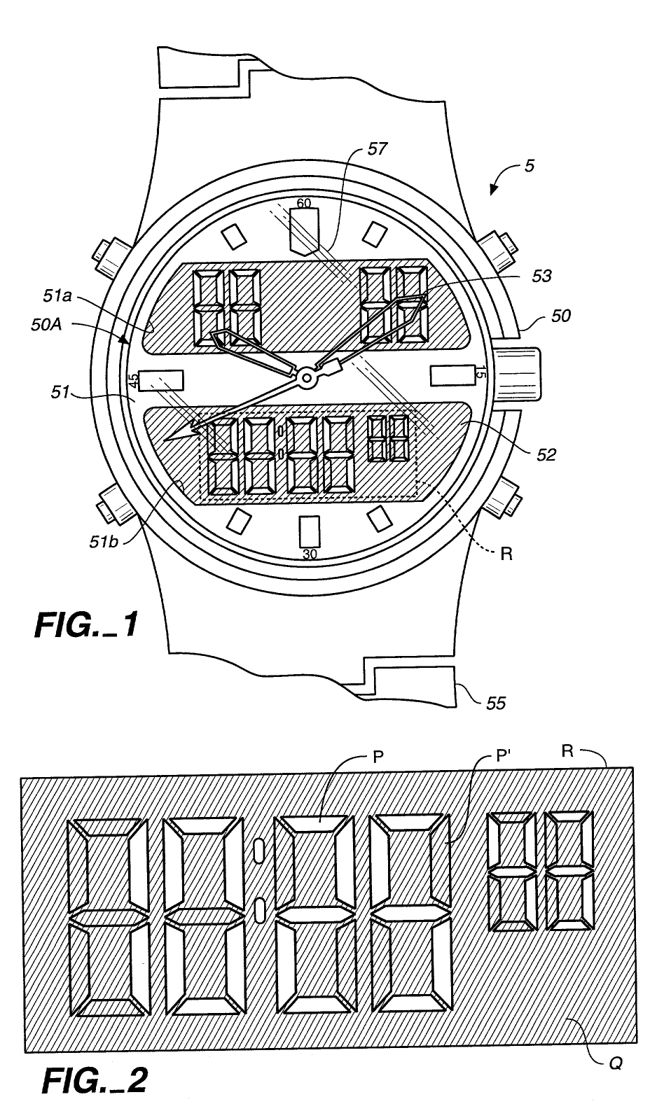

With reference to FIGS. 1 and 2, an example of the structure of an electronic apparatus which is provided with a liquid crystal display device according to the present invention is shown. FIG. 1 is a schematic plan view showing a major portion of a watch 5 provided with a liquid crystal display device of the present invention. FIG. 2 is a schematic plan view showing an enlarged display area R of FIG. 1.

As shown in FIG. 1, watch 5 comprises a watch body 50 and a strap 55 connected to this watch body 50. A time information display portion 50A covered by a transparent glass 57 is formed at the front side of watch body 50. The time information display portion 50A is preferably composed of the following item: an analog display panel 51 having two apertures 51a and 51b; a liquid crystal display device 52 which is provided at the rear side of analog display panel 51 and a portion of it arranged to be viewed through apertures 51a and 51b; and a hands portion 53 composed of an hour hand, a minute hand, or the like, which penetrate the central portion of analog display panel 51 and the central portion of a liquid crystal panel of liquid crystal display device 52 and which are connected to a movement not shown in the figure. Time information, such as the current time, a timer, elapsed time, alarm time, or world time, is displayed on time information display portion 50A in accordance with user's selection. In addition, in accordance a design choice, the analog display panel 51 or the hands portion 53 may, or may not, be provided. The liquid crystal display device 52 is not limited to a mono-layer structure and may have a multilayer structure composed of at least two layers. Furthermore, the cross-section of the liquid crystal display device 52 is not limited to a flat shape, and the cross-section thereof may have a curved shape.

The display area R is provided on the liquid crystal display device 52 so as to be viewed through aperture 51b of analog display panel 51. As shown in FIG. 2, this display area R is composed of a plurality of P pixels and P′ pixels and a non-display portion Q (background portion) formed on regions of display area Rnot occupied by P or P′ pixels. Each of the P and P′ pixels has an elongated strip shape extending in a predetermined direction, and in the example shown in the figure, the pixels preferably form a general seven-segment structure arranged in a figure-eight formation. Any portion of the seven-segment structure may be selectively activated for displaying any numeral. The arrangement of the pixels is not limited to present seven-segment arrangement, and it may, for example, have a dot matrix display arrangement.

Among the plurality of pixels in the display area R of this embodiment, the color tone of P pixels, which together construct a displayed numeral, are different from the color tone of P′ pixels, which are not used in the construct of the displayed numeral. In addition, the color tone of P′ pixels and the color tone of non-display portion Q are preferably, approximately equivalent to each other. Therefore, the color tone of P pixels is of higher contrast from the color tone of non-display portion Q than is the color tone of P′ pixels. That is, the difference in color tone of P pixels from that of non-display portion Q is more easily discernable than the difference in color tone of P′ pixels from that of non-display portion Q. More specifically, the color tone of P pixels is preferably a bright color (for example, white or another light color), and the color tones of P′ pixels and non-display portion Q are both preferably dark colors (for example, black or another dark color), so that a display mode which ensures visibility by luminosity may be formed. In the case described above, a display mode of a so-called negative pattern is formed. In addition, a display mode which ensures visibility by a difference in color hue may be formed in which, for example, the color tone of P pixel is blue, and the color tones of both P′ pixels and non-display portion Q are red. Applying this to the case described above, a two-color pattern (i.e. multicolor) display mode is formed.

In display area R, each of the plurality of pixels is formed so that the viewing mode thereof each pixel selectively has one of the color tone of a P pixel and the color tone of a P′ pixel, as shown in the figure. The structure that permits the viewing mode of each pixel to be selectively changed will be described in detail in the embodiments described below.

First Embodiment

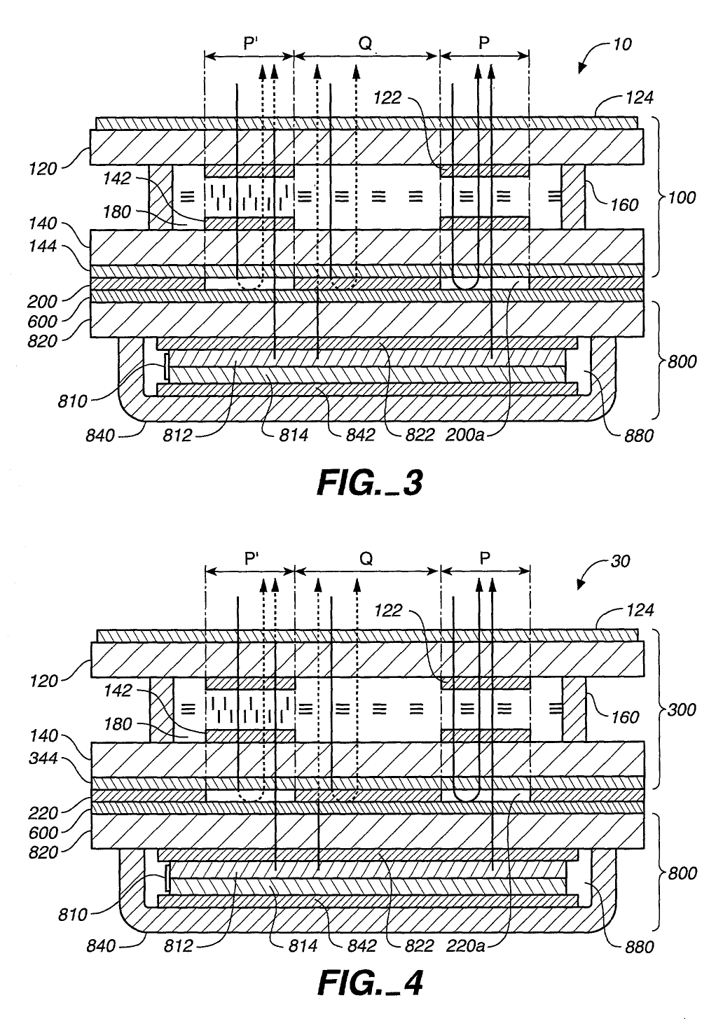

Liquid crystal display device 52 of FIG. 1 may have several configuration. With reference to FIG. 3, a first exemplary configuration of liquid crystal display device 52 according to a first embodiment of the present invention is shown as cross-sectional view 10 In the present embodiment, liquid crystal display device 52 of FIG. 1, as illustrated in cross-sectional view 10 of FIG. 2 includes the following items: a liquid crystal panel 100 composed of a pair of substrates 120 and 140 formed of a glass, or similar material, with a liquid crystal layer 180 provided between substrates 120 and 140; a light modulation layer 200 provided at the rear side of liquid crystal panel 100; a reflective layer 600 provided at the rear side of light modulation layer 200; and a backlight 800 provided at the rear side of reflective layer 600.

In liquid crystal panel 100, substrates 120 and 140 are bonded together by a sealing material 160 so as to form a cavity between substrates 120 and 140, and liquid crystal layer 180 is formed by enclosing liquid crystals inside the cavity. Transparent electrodes 122 and 142 formed by deposition or sputtering of ITO (Indium Tin Oxide), or similar material, are provided on the inside surfaces of substrates 120 and 140, respectively. Areas at which the transparent electrodes 122 and the transparent electrodes 142 overlap each other form the P and P′ pixels described above. Polarizers 124 and 144 are adhered to the outside surfaces of substrates 120 and 140, respectively.

The liquid crystal panel 100 is formed so as to permit the transmission of light when a voltage is not applied by transparent electrodes 122 and 142, and to not permit the transmission of light when a voltage is applied by transparent electrodes 122 and 142. Liquid crystal panel 100 may optionally be, for example, a TN (twisted nematic) type liquid crystal panel. In the case described above, the liquid crystal layer 180 has a twist angle of 90°, i.e. an optical activity of 90°, in an initial orientation state, and when a predetermined voltage or more is applied, the liquid crystal layer 180 has a substantially isotropic optical property. This is because the application of the predetermined voltage causes the liquid crystals to become partially oriented toward the direction of the resultant electric field, that is, in the direction defined by the panel thickness, and thus loose their defined twist angle of 90°. In the case described above, the polarizer 124 and the polarizer 144 are disposed so that their respective polarization axes are perpendicular to each other. Hereinafter, based on the assumption that liquid crystal panel 100 is a TN type liquid crystal panel, the case will be described in which the polarizer 124 is formed to have a polarization axis in parallel with the plane of the figure and an absorption axis perpendicular thereto. That is, the polarizer 124 is formed to transmit a polarization component having a transmission plane in parallel with the plane of the figure and to absorb a polarization component having a transmission plane perpendicular thereto. The case is also described in which the polarizer 144 is disposed so that its polarization axis and its absorption axis are oriented 90° from the respective polarization axis and the absorption axis of the polarizer 124.

However, the present invention is not limited to liquid crystal panels using a TN (twisted nematic) mode. The present invention may be applied to a liquid crystal panel having a combination of a liquid crystal layer provided with a controllable retardation property and polarization means, such as an STN (super twisted nematic) mode, or may be applied to any another liquid crystal panel of a polymer dispersed type, a guest-host type, a dynamic scattering mode type, or other similar type.

The light modulator 200 is disposed at the rear side of the liquid crystal panel 100, that is, it is disposed on the outside surface of polarizer 144. Window portions 200a are provided in the light modulator 200 at positions defining first areas, and regions of light modulator 200 not having a window are defined as second areas. The window portions 200a are formed into a flat shape so as to approximately overlap the position of the P and P′ pixels in a plan view. It is preferable that the window portion 200a be formed so as to be slightly smaller than the area of each of the P and P′ pixels. It is also preferably that the inside peripheries boundaries of the light modulator 200, which correspond to the borders of the window portions 200a, be disposed slightly inside the regions defined by the position of the P and P′ pixels when viewed in plan view. According to the structure thus formed, it can be difficult to view the inside periphery of the window portion 200a, that is, the boundary of the first area to the second area, from the outside when a pixel is in a light blocking state, i.e. P′.

In general, a light modulator functions to modulate light, and more particularly, is formed so as to change the spectral distribution of light, which is emitted from the liquid crystal panel, in the visible light range. Due to this change in the spectral distribution, the viewing mode of the display area of the liquid crystal panel is provided with a predetermined color tone, that is, it is provided with predetermined luminosity and hue. In addition, both a light modulator which functions to change the spectral distribution by transmitting light therethrough or a light modulator which functions to change the spectral distribution by reflecting light may be used.

The light modulator 200 of this embodiment essentially influences the spectral distribution of light that passes therethrough, and for example, the light modulator 200 may be formed of a filter containing a color agent, such as a dye or a pigment, having a specific hue. In addition, in this embodiment, the window portion 200a of the light modulator 200 is formed so as to transmit light therethrough while the spectral distribution thereof is maintained. The light modulator 200 may be a laminate formed by laminating a modulation layer having a predetermined hue by deposition or sputtering on a transparent substrate composed of a transparent resin film or the like having openings corresponding to the window portions 200a. Alternatively, the light modulation film 200 may be formed by punching or cutting the window portions 200a of a plate which is composed of a resin or the like mixed with a color agent such as a pigment or a dye, and which has a specific hue.

The reflector 600 is disposed at the rear side of the light modulator 200 described above. The reflector 600 of this embodiment is a transflective layer having both a reflection property and a transmission property. The reflector layer 600 is formed of, for example, a thin-film metal layer of Al, Cr, or the like having a sufficient thickness so as to have a transflective property. The reflector 600 may be formed directly on the surface of the light modulator 200 or may be formed on a substrate composed of a transparent film or the like by deposition, sputtering, or the like.

The backlight 800 may be any type of light source, such as a plane light source composed of a light-emitting element and a light guide plate, as long as it can illuminate the liquid crystal panel 100 from the rear side thereof. In the present embodiment, backlight 800 is preferably an organic luminescent panel, which is another type of plane light source, is used. The backlight 800 has a known structure formed by sealing a light-emitting layer 810 using a substrate 820 composed of a glass, or other similar material, and a sealing glass 840 provided at the rear side thereof. A transparent electrode 822 formed by deposition or sputtering of ITO is provided on the rear side surface of the substrate 820. An electron transport layer 812 is formed on the transparent electrode by deposition or sputtering, and a hole transport layer 814 is further formed on the electro transport layer by deposition or electrolytic polymerization. The electron transport layer 812 and the hole transport layer 814 form the light-emitting layer 810 described above. A metal electrode 842 formed of a co-deposition film composed of magnesium and silver is formed by deposition, sputtering, or other known technique on the surface of the light-emitting layer 810. The space around the light-emitting layer 810 is filled with silicone oil 880, and the entire light-emitting layer is sealed by the sealing glass 840.

In the cross sectional view 10 of the liquid crystal display device 52 of the embodiment of FIG. 3 thus described, a display mode can be viewed since incident external light is reflected on the reflective layer 600, and in addition, a display mode can also be viewed by transmitting part of the luminous light emitted from the backlight 800 through the reflective layer 600, whereby a transflective liquid crystal display device is formed.

In a P pixel, which according to this embodiment is a pixel to which a voltage is not applied, incident external light passing through the liquid crystal panel 100 in a light transmission state and a window portion 200a of the light modulator 200 is reflected on the reflective layer 600. The reflected light then passes again through the window portion 200a and crystal panel 100, and is thereby emitted to the outside. In addition, part of the luminous light emitted from the backlight 800 passes through the reflective layer 600 (due to its transflective property), window portion 200a, and liquid crystal panel 100 to be emitted to the outside. Accordingly, a P pixel exhibits a bright viewing quality (white color).

In addition, external light incident to a P′ pixel, which according to the present embodiment is a pixel to which a voltage is applied, cannot pass through liquid crystal panel 100, which is in a light blocking state. Although part of the luminous light emitted from backlight 800 enters the liquid crystal panel 100 after passing through reflective layer 600 and a window portion 200a, the emitting luminous light cannot pass through the liquid crystal panel 100, as represented by dash line in FIG. 3. As a result, P′ pixels exhibit a dark viewing quality (black color).

Furthermore, when external light enters a non-display portion Q, it passes through the liquid crystal panel 100, reaches a non-window portion of the light modulation layer 200, and is then modulated by light modulation layer 200. After the light passing through the light modulation layer 200 is reflected on reflective layer 600, the reflected light again passes back through the light modulation layer 200 and the liquid crystal panel 100 before being emitted. Although part of the luminous light emitted from backlight 800 passes through reflective layer 600, it is modulated by light modulation layer 200 before passing through liquid crystal panel 100 and being emitted. Therefore, the non-display portion Q exhibits a viewing quality determined by the amount of light modulation in the light modulation layer 200. That is, non-display portion Q exhibits a viewing quality in accordance with the color tone of light modulation layer 200.

In this embodiment, the light modulation layer 200 is formed of a black filter or a black layer. As a result, a dark color (or black color) is always viewed in the non-display portion Q, a bright color (white color) is viewed in the P pixelportion, and a dark color (black color) is viewed in the P′ pixel portion. Accordingly, a display mode of a reverse display (negative pattern display) is realized in the display area R.

In the case in which a general display (positive pattern) is created by a generally normally white liquid crystal panel, pixels under the influence of an applied electric field form a display pattern (numerals, letters, or figures). A similar structure as described above for the creation of a negative pattern display may be used in the creation of a positive pattern display by reversing the location of window regions to non-window regions of patter of light modulation layer 200 and the placement of electrodes 142 and 122 to be the opposite as the case described above.

In the present negative pattern display, a P pixels is placed in an nonapplication stated defined as a state in which no electric field is applied to it. Pixels needed for forming a desired image are thus defined as P pixels and are placed in a non-application state to form a display pattern having a bright viewing mode. Conversely, a P′ pixel is placed in an application state, defined as a state in which an electric field is applied to it. Pixels not needed for forming a desired image are thus defined as P′ pixels and are placed in an application state to form a darken field in the display pattern, the P′ pixels would have a dark viewing mode equivalent to that of the non-display portion Q, which is used as the background. Accordingly, the P and P′ pixels create display using a liquid crystal driving circuit, which is not shown in the figure. For example, when numeral “2” is displayed by a seven-segment pixel group, five pixels are defined as P pixels by placing them in the non-application state of an electric field, and the remaining 3 pixels are defined as P′ pixels and placed in the application state of an electric field.

In this specific example of liquid crystal display device 52 as illustrated by cross sectional view 10, since a specific viewing mode can be obtained by light modulation using the light modulator 200 in the non-display portion Q, which is formed on regions of display area R not occupied by P and P′ pixels, a reverse display (negative pattern) can be created even when a normally white liquid crystal panel 100 is used.

In addition, when performing reverse display, since the normally white liquid crystal panel 100, which is in a light transmission state when an electric field is not applied, is used, a bright viewing mode P pixels can be realized at the initial orientation, or operating, stage of liquid crystal. Therefore, P pixels can obtain a high luminosity and be assured of a relatively wide viewing angle without requiring the application of a high voltage. As a result, the overall display quality of the image is improved. Typically, the manufacture of a reverse displays would require the use of STN mode liquid crystal panels, which are relatively expensive and difficult to procure. However, since the liquid crystal display device 52 of FIG. 3 achieves a reverse display of superior display quality using a TN mode liquid crystal panel 100, as described above, an STN mode liquid crystal panel is no longer necessary, whereby the production cost can be reduced and difficulties in procurement of liquid crystal panels can also be avoided.

Additionally in the present embodiment, since it is not necessary to apply an electric field to the non-display portion Q, as opposed to the case where a reverse display is realized by controlling the entire display area R of a normally white liquid crystal panel having pixels throughout the entire display area R, only P and P′ pixels need to be reversely driven. As a result, electrical power consumption can be significantly reduced. In addition, by reversely driving only the P and P′ pixels, the electrical power consumption is also reduced when compared to the case in which a positive pattern is displayed. The reason for this is that since a negative pattern display, such as the present embodiment, requires that an electrical field be applied only to non-display P′ pixels, the number of pixels that require the application of an electric field is smaller than when a positive pattern is displayed. For example, when numeral “0” is displayed using a seven-segment pixel group, the number of pixels to which an electric field is applied in a conventional positive display panel is six, but the number of pixels requiring an applied electric field in this embodiment is one. In addition, in this embodiment, when numeral “1” is to be displayed, the number of pixels requiring the application of an electric field is five. Similarly, the number of pixels requiring an applied electric field to display numeral “2” is two. Therefore, the number of pixels to which an electric field is applied to generate a numeral display in the present embodiment can be reduced to one-half or less as a whole. Accordingly, the electric power consumption can be significantly reduced as compared to that of a conventional positive pattern display.

In the embodiment of FIG. 3, light modulator 200 is disposed between polarizer 144 and the reflective layer 600. However, the position at which light modulator 200 is disposed is not limited to being between polarizer 144 and reflective layer 600. Light modulator 200 may be disposed at any position as long as light modulator 200 is disposed above reflective layer 600. However, when the dark viewing mode of a P′ pixel is viewed from the outside in this embodiment, it seems to be located at a position equivalent to the depth of the rear side portion of liquid crystal panel 100. That is, it appears to be located at a position equivalent to the depth at which polarizer 144 is disposed. Accordingly, in order to make the depth of the light modulator 200, which realizes the dark viewing mode in the non-display portion Q, equal to the position at which a dark viewing mode of a P′ pixel is apparently viewed in order to improve visibility, the light modulator 200 is most preferably disposed at the rear side of liquid crystal panel 100. In other words, it is preferably located between the polarizer 144 and reflective layer 600, or between substrate 140 and polarizer 144.

Second Embodiment

With reference to FIG. 4, a second exemplary configuration of liquid crystal display device 52 according to a second embodiment of the present invention is shown as cross-sectional view 30. The same reference labels in the first embodiment designate the same elements in this embodiment, and their descriptions are therefore omitted. As shown in cross-sectional view 30, liquid crystal display device 52 in the present embodiment is composed of a liquid crystal panel 300; a light modulation layer 220 provided at the rear side of the liquid crystal panel 300; a reflective layer 600; and a backlight 800. Reflective layer 600 and backlight 800 preferably have the same structures as those described in the first embodiment of FIG. 3.

The liquid crystal panel 300 has substrates 120 and 140, a sealing material 160, and a liquid crystal layer 180, which are equivalent to those in the first embodiment of FIG. 3. A polarizer 124 equivalent to that in the first embodiment is adhered to the outside surface of the substrate 120. A color polarizer 344 is adhered to the outside surface of the substrate 140. This color polarizer 344 has a polarization axis and an absorption axis equivalent to those of polarizer 144 of the first embodiment. However, color polarizer 344 is formed so as not to uniformly absorb polarization components, having a transmission plane in parallel with the absorption axis, in the entire visible wavelength region. It is further formed so as to transmit light in a specific wavelength region. That is, it is formed so as to form a predetermined polarized spectral distribution of the polarization component described above. The specific wavelength region described above may be any region in the visible light range and may include a plurality of wavelength regions. In the present embodiment, the case where the specific wavelength region selected for light transmission is the red color region (i.e., a region at the end of the long wavelength side of the visible light range) will be described below by way of example.

The light modulator 220 of this embodiment is provided with window portions 220a at regions corresponding to P and P′ pixels, as in the first embodiment of FIG. 3, but is further formed so as to serve as a red filter for forming light approximately equivalent to the spectral distribution having a specific wavelength region, which is formed by the color polarizer 344.

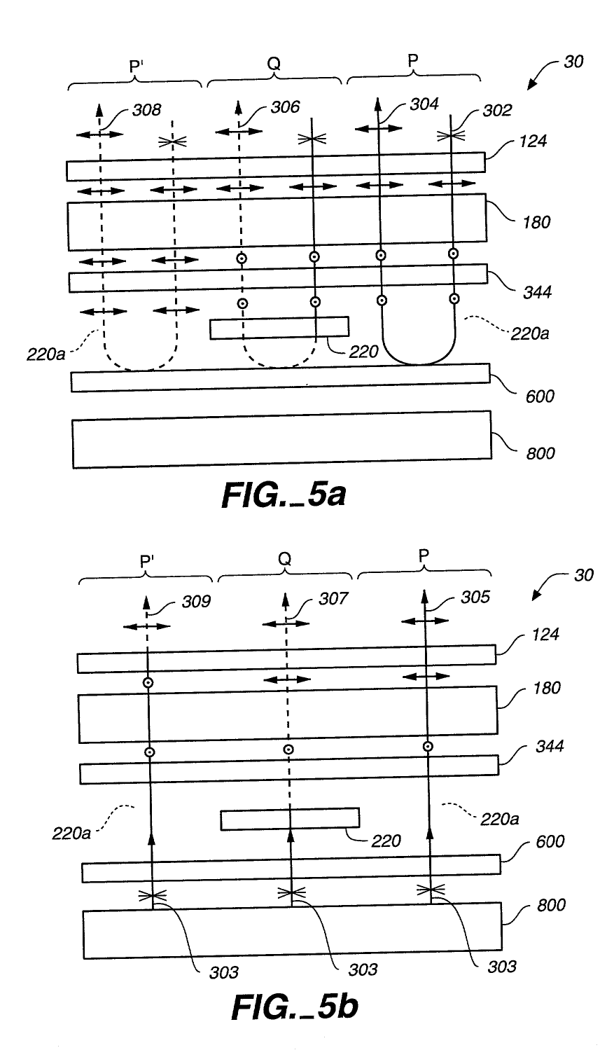

With reference to part (a) of FIG. 5, a simplified schematic view of cross sectional view 30 of liquid crystal display device 52 illustrates an optical structure for performing a display mode of the present second embodiment in which externally applied incident light is used to create a visible display.

In the section illustrating a P pixel, an electric field is not applied and externally applied incident light 302 passes through polarizer 124 and becomes a linearly-polarized light having a transmission plane in parallel with the plane of the figure. Subsequently, the polarization direction of the polarized light is twisted by 90° by the liquid crystal layer 180 so as to be linearly-polarized light having a transmission plane perpendicular to the plane of the figure, passes through the color polarizer 344 while maintaining its polarized state, and is reflected on the reflective layer 600 after passing through window portion 220a. This reflected linearly-polarized light perpendicular to the plane of the figure is again twisted by 90° by the liquid crystal layer 180 after passing through the color polarizer 344 so as to be linearly-polarized light having a transmission plane in parallel with the plane of the figure, and the polarized light coming up through liquid crystal layer 180 is emitted from polarizer 124 as linearly-polarized light 304 having a transmission plane in parallel with the plane of the figure. As explained above, since a P pixel in liquid crystal panel 300 is in a light transmission state, the emitted light 304 is white light and the P pixel exhibits a bright (white) viewing mode.

By contrast in the section illustrating a P′ pixel, an electric field is applied and externally applied incident light passes through polarizer 124 to form linearly-polarized light having a transmission plane in parallel with the plane of the figure. This linearly-polarized light passes through liquid crystal layer 180 without changing its polarization direction (due to the applied electric field), and then enters color polarizer 344. Since color polarizer 344 has an absorption axis in parallel with the transmission plane of this linearly-polarized light, the red light component of the linearly-polarized light passes color polarizer 344 while the other color components of the linearly-polarized light are absorbed. Subsequently, the red linearly-polarized light passes through window portion 220a and is reflected back by reflective layer 600. The reflected light again passes through color polarizer 344, liquid crystal layer 180, and polarizer 124 before being emitted from the polarizer 124 as red linearly-polarized light 308 having a transmission plane in parallel with the plane of the figure. Accordingly, the P′ pixel exhibits a red viewing mode.

Furthermore, in the non-display region Q, externally applied incident light passing through polarizer 124 is converted into linearly-polarized light having a transmission plane in parallel with the plane of the figure. No electric field is applied to the non-display regions Q of the display. Therefore, when this linearly-polarized light passes through the liquid crystal layer 180, the polarization axis of the linearly-polarized light is twisted by 90° so as to form linearly-polarized light having a transmission plane perpendicular to the plane of the figure, and the linearly-polarized light thus formed reaches the light modulator 220 after passing through the color polarizer 344. Red linearly-polarized light is formed when the linearly-polarized light passes through light modulator 220. The resultant red linearly-polarized light is then reflected back by reflective layer 600, and again passes through light modulator 220 and color polarizer 344, in this order. Subsequently, the polarization direction of the red linearly-polarized light is again twisted by 90° by liquid crystal layer 180 so as to form red linearly-polarized light having a transmission plane in parallel with the plane of the figure, and this red linearly-polarized light is emitted from through polarizer 124 as red linearly-polarized light 306 having a transmission plane in parallel with the plane of the figure. Accordingly, the non-display portion exhibits a red viewing mode.

With reference to part (b) of FIG. 5, a display mode created by luminous light emitted from backlight 800 of the liquid crystal display device 52 according to the present embodiment illustrated by cross sectional view 30 will be described.

In the region defining a P pixel, after part of light 303 emitted from backlight 800 passes through the reflective layer 600 and the window portion 220a, it passes through color polarizer 344. A polarization component of light 303 having a transmission plane perpendicular to the plane of the figurepasses through color polarizer 344. Among the polarization components having a transmission plane in parallel with the plane of the figure, those having a red color pass through color polarizer 344, and those having another color are absorbed by color polarizer 344. Accordingly, light components, other than red color components, i.e. a non-red light component is formed into light having a transmission plane perpendicular to the figure. Subsequently, since the liquid crystal layer 180 twists the polarization direction by 90°, the light in the non-red light component is formed into linearly-polarized light having a transmission plane in parallel with the plane of the figure, and this linearly-polarized light passes through the polarizer 124 while maintaining the polarized state thereof. In addition, concerning the red color component light, only linearly-polarized light having a transmission plane in parallel with the plane of the figure passes through the polarizer 124, and since the red color component entering liquid layer 180 from color polarizer 344 already had a transmission plane in parallel with the plane of the figure, the polarization twisting action of liquid layer 180 caused the red color component to acquired a transmission plane perpendicular to the plane of the figure. As described above, only linearly-polarized light 305 having a transmission plane in parallel with the plane of the figure is emitted from the polarizer 124, and the red-color components are therefore blocked. Accordingly, the P pixel region exhibits a bright (white) viewing mode.

In the region defining a P′ pixel, after part of light 303 emitted from the backlight 800 passes through reflective layer 600 and window portion 220a, it passes through the color polarizer 344. When passing through color polarizer 344, a red color component of light, i.e. light in the red color spectrum, or region, passes through while maintaining its polarization state. However, among the other light color regions, only polarization light having a transmission plane perpendicular to the plane of the figure passes through color polarizer 344. The light described above passes through the liquid crystal layer 180 while maintaining its polarization state and enters polarizer 124. Since polarizer 124 only transmits a polarization component having a transmission plane in parallel with the plane of the figure, light in regions other than the red color region is all absorbed by polarizer 124, and only the light in the red color region is emitted from the polarizer 124 as linearly-polarized light 309 having a transmission plane in parallel with the plane of the figure. Accordingly, the P′ pixel exhibits a red viewing mode.

Furthermore, in the region of the display representing a no-display portion Q, after part of light 303 emitted from the backlight 800 passes through the reflective layer 600, the light 303 is turned into light in the red color region when passing through the light modulator 220, and then enters the color polarizer 344. Color polarizer 344 does not substantially absorb the light in the red color region but transmits the light there-through. Subsequently, after the light in the red color region passes through the liquid crystal layer 180, linearly-polarized light 307 in the red color region having a transmission plane in parallel with the plane of the figure is formed when the light passes through the polarizer 124 and is then emitted. Accordingly, the non-display portion Q exhibits a red viewing mode.

As described above, according to this embodiment, in both the reflective display using external light and the transmissive display using a backlight, P pixels exhibit a bright color (white color), and both the P′ pixels and non-display portion Q of the display exhibit a red color. Accordingly, the display mode of this embodiment is a reverse display (negative pattern) of red color.

In this embodiment, the case in which color polarizer 344 transmits red light and light modulator 220 forms red light was described. However, this embodiment can be applied to the case in which light in a specific region formed by the color polarizer 344 and light modulated by the light modulator 220 are light in various wavelength regions other than the red light region, such as green light region, blue light region, etc.

In this embodiment, color polarizer 344 is disposed at the rear side of the liquid crystal layer 180. However, color polarizer 344 at the rear side of the liquid crystal layer 180 may be replaced by a general polarizer. Additionly, general polarizer 124 disposed at the front side of the liquid crystal layer 180 may be replaced by a color polarizer. Furthermore, both polarizers disposed at the front side and the rear side of the liquid crystal layer 180 may be color polarizers. In these alternate three cases, a display mode substantially equivalent to that described above can be realized.

Third Embodiment

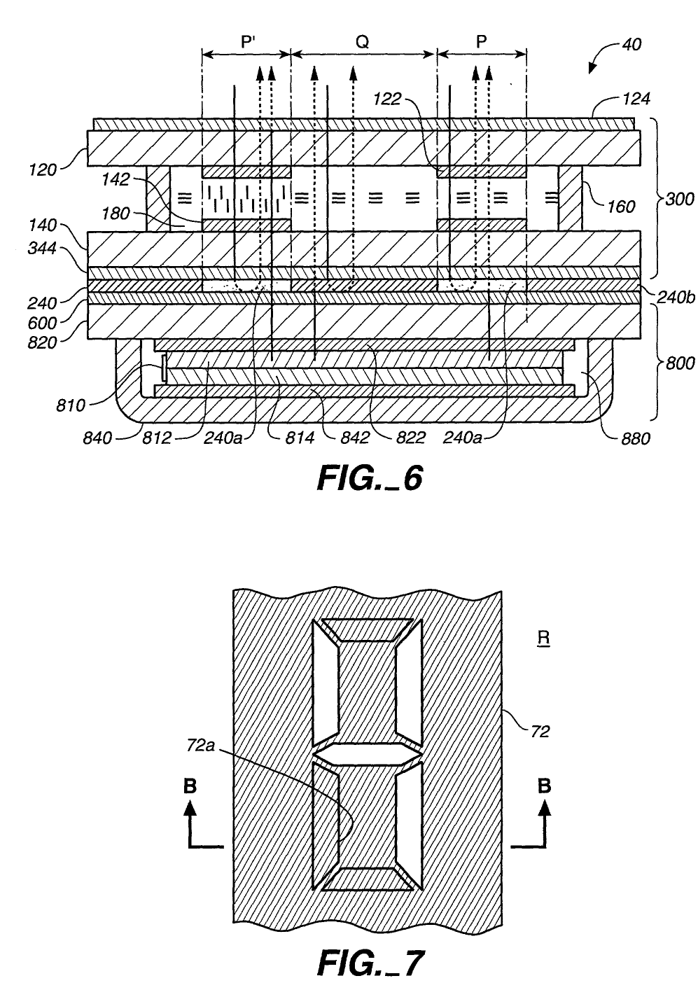

Next, referring to FIG. 6, a liquid crystal display device according to a third embodiment of the present invention will be described. In this embodiment, elements similar to those of the first and second embodiments have similar reference characters and their respective descriptions are omitted. In this embodiment, the liquid crystal display device 52, as illustrated by cross sectional view 40, includes the same liquid crystal panel as the liquid crystal panel 300 of the second embodiment described above, and includes a reflective layer 600 and backlight 800 that are the same as those in the first and the second embodiments.

As shown in FIG. 6, a light modulator 240 of this embodiment comprises a first filter portion 240a corresponding to a first area and a second filter portion 240b corresponding to a second area. The first filter portion 240a and the second filter portion 240b have light modulation functions different from each other. For example, their respective hues may be different from each other. The light modulation functions of the individual filter portions are not specifically limited as long as the filter portions are formed so as to realize their own viewing modes different from each other. Hereinafter, as a particular example, the case will be described by way of example in which the first filter portion 240a is a yellow filter (that is, a filter substantially having light transmission properties in both the red color region and the green color region), and the second filter portion 240b is a red color filter.

In the region of cross sectional view 40 representing a P pixel, a voltage is not applied, and when externally applied light passes through the liquid crystal panel 300, the external light is turned into linearly-polarized light having a transmission plane perpendicular to the plane of the figure. This linearly-polarized light is subsequently turned into yellow light having wavelength components in the red color region and the green color region when passing through first filter portion 240a, and the yellow light is then reflected by reflective layer 600. Next, the light again passes, in order, through the first filter portion 240a and liquid crystal panel 300, and is then emitted as yellow light. Accordingly, the P pixel exhibits a yellow viewing mode.

In the region of cross sectional view 40 representing a P′ pixel, a voltage is applied, and when externally applied light passes through the liquid crystal panel 300, the external light is turned into linearly-polarized light having a transmission plane in parallel with the plane of the figure by polarizer 124. This linearly-polarized light having a transmission plane in parallel with the plane of the figure maintains its polarized state after passing through the liquid crystal layer 180, due to no voltage being applied. Among polarization components having a transmission plane in parallel with the plane of the figure, light in regions other than the red color region is absorbed. Thus, only the light in the red color region passes through first filter 240a. Since the light in the red color region can pass through the first filter portion 240a, the red light is reflected by reflective layer 600. The reflected red light than again passes in order through color polarizer 344 and liquid crystal layer 180 before being emitted from polarizer 124. Accordingly, the P′ pixel exhibits a red viewing mode.

The region of cross sectional view 40 representing a non-display portion Q always exhibits a red viewing mode due to the filter characteristics of the second filter portion 240b of light modulator 240, as explained above in reference to the second embodiment.

Furthermore, concerning the viewing mode obtained by luminous light emitted from the backlight 800, as is the cases described above, the P pixel, the P′ pixel, and the non-display portion Q respectively exhibit a yellow, a red, and a red viewing mode.

As described above, in this embodiment, the non-display portion Q always exhibits a red viewing mode. Depending on an application state of an electric field, a red viewing mode approximately equivalent to that of the non-display portion Q or a yellow viewing mode can be optionally shown in the P′ and P pixels. Accordingly, a two-color display mode, for example, a red and a yellow display mode described in the above particular example, can be realized in this embodiment.

In this embodiment, the viewing mode of the P′ pixel is determined by the light modulation property of the first filter portion 240a and the light absorption property of color polarizer 344. For example, concerning the hue, the viewing mode of the P′ pixel is determined in accordance with a modulated spectral distribution obtained by the first filter portion 240a and a polarized spectral distribution of a polarization component having a transmission plane in parallel with the absorption axis of the color polarizer 344. In the case according to this embodiment, in more particular, the viewing mode of the P′ pixel is determined by subtract mixing of the modulated spectral distribution obtained by the first filter portion 240a and the polarized spectral distribution of the polarization component formed by the color polarizer 344. The viewing mode of the P pixel is determined only by the modulated spectral distribution obtained by the first filter portion 240a.

Accordingly, in this embodiment, in order to make the viewing mode of the P′ pixel approximately equivalent to the viewing mode of the non-display portion Q, it is necessary that the product of spectral distribution, which is formed by performing a subtract process (or a multiply process) using the modulated spectral distribution obtained by the first filter portion 240a and the polarized spectral distribution of the polarization component obtained by the color polarizer 344, be approximately equivalent to the modulated spectral distribution obtained by the second filter portion 240b. For example, in a case other than the particular example described above, if the color polarizer 344 is equivalent to that of the particular example when the first filter portion 240a has a transmission property in the red and blue color regions (that is, a magenta filter) and the second filter portion 240b is a red filter, then a magenta display pattern can be obtained on a red background. In addition, when the second filter portion 240b is a blue filter, a magenta display pattern is obtained on a blue background. Furthermore, in the case in which the color polarizer 344 has a property which transmits only light in the green color region among polarization components each having a transmission plane in parallel with the absorption axis of the polarizer, and the first filter portion 240a has the transmission property in the red and blue color regions , the P pixel exhibits a yellow viewing mode while the P′ pixel exhibits a green viewing mode. In this case, in order to form a green background, it is necessary that the second filter portion 240b also have an optical property that transmits only light in the green color region there-through.

As described above, a two-color display can be achieved according to this embodiment, and hence, a colorful display mode can be realized. In the case described above, in addition to a seven-segment pixel group described in the above embodiments, optional pattern displays, for example, image figures such as a specific icon or character, or some other figure, can be displayed in a color viewing mode, or not. In addition, by forming a figure using a plurality of pixels, an animation display (movie display) of an optional pattern can be realized in a color viewing mode.

In the embodiment described above, the case is described by way of example in which only the first area (first filter portion) and the second area (second filter portion) are provided as light modulation means. However, by providing at least two first areas, at least three different hues can be realized. In the case described above, when every modulated spectral distribution formed by the plurality of first areas includes light wavelength regions of polarized spectral distributions obtained by the color polarizer, viewing modes obtained by the polarized spectral distributions can be optionally realized in every pixel.

According to this embodiment, the liquid crystal display device described above has functions equivalent to those of a liquid crystal display device provided with a reflective polarizer (which transmits a polarization component having a transmission plane in a predetermined direction and reflects a polarization component having a transmission plane in another direction) at the rear side thereof and provided with optional light modulation means at the rear side of the reflective polarizer. In addition, the liquid crystal display device according to this embodiment can be manufactured at low cost without using the reflective polarizer.

Fourth Embodiment

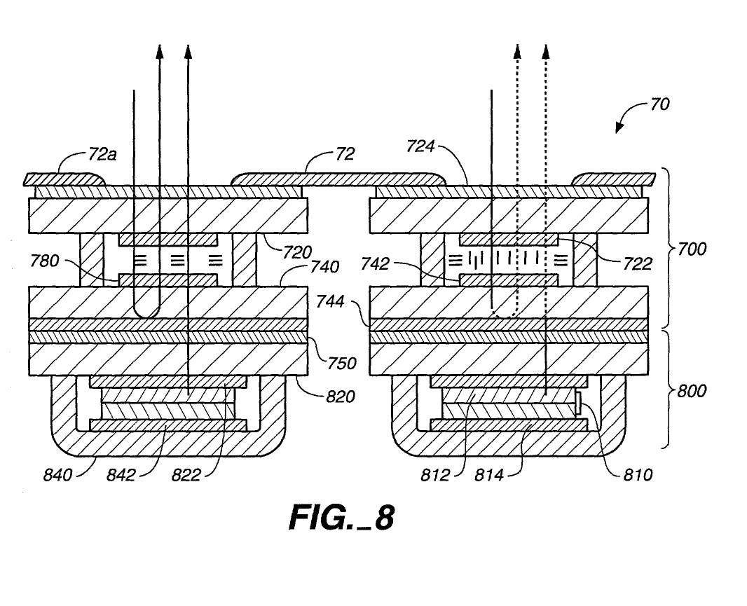

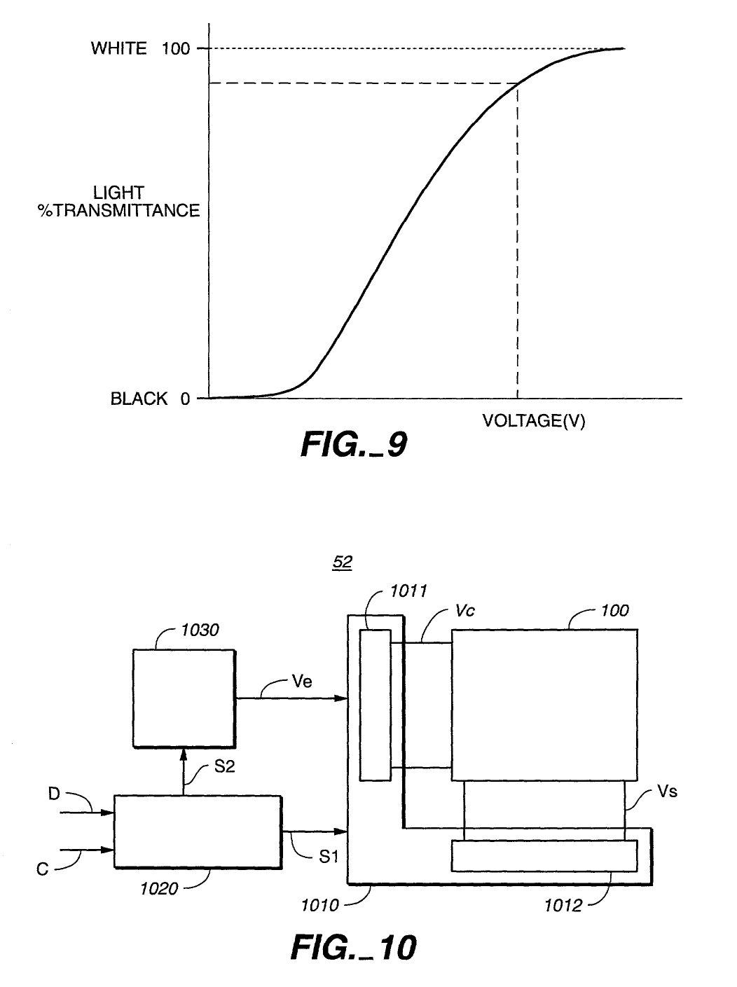

Next, referring to FIGS. 7 and 8, a liquid crystal display device 52 of a fourth embodiment of the present invention, as exemplified by cross sectional view 70 in FIG. 8, will be described. FIG. 7 is a view showing a part of a display area R according to the fourth embodiment. FIG. 8 is a partly vertical cross-sectional view taken along the line B-B in FIG. 7. All elements similar to the above described embodiments have similar reference characters and their respective descriptions are found above. As shown in FIG. 7, a liquid crystal display device 52 has a light modulator 72 provided on the top of the display area. This light modulator 72 has a predetermined color tone on the surface (outside surface) thereof, and this color tone can be obtained by, for example, forming a print layer composed of a paint, or similar substance, appropriately mixed with a color agent such as a pigment or a dye, on a surface of a plate-shaped substrate composed of an optional material. This light modulator 72 is provided with a plurality of display windows 72a therein. In the example shown in the figure, the display windows 72a form a shape equivalent to that of a seven-segment pixel group.

As shown in FIG. 8, one liquid crystal panel 700 is provided at the rear side of each display window 72a, and the display area of each liquid crystal panel 700 is formed so as to be viewed through each display window 72a. These liquid crystal panels 700 are each formed of a pair of substrates 720 and 740 and liquid crystal layer 780 composed of liquid crystal enclosed between the two substrates. Substrates 720 and 740 are composed of a glass, or similar material, bonded together by a sealing material. Opposing transparent electrodes 722 and 742 are formed on the inside surfaces of the substrates 720 and 740, respectively. In addition, polarizers 724 and 744 are adhered to the outside surfaces of the substrates 720 and 740, respectively.

As in the cases of the embodiments described above, this liquid crystal panel 700 is a so-called normally white liquid crystal panel which is placed in a light blocking state when a voltage is applied between the transparent electrodes 722 and 724 constituting the display area, and which is placed in a light transmission state when a voltage is not applied. A general liquid crystal panel (such as a dot matrix type panel) having a plurality of pixels may by used as the liquid crystal panel 700 of this embodiment. However, since it is satisfactory to have one display mode is performable on the entire panel surface, this liquid crystal panel 700 may have a single pixel formed of a pair of transparent electrodes provided on the internal surfaces of the two substrates so as to cover the display area.

A reflective layer 750 is provided at the rear side of the liquid crystal panel 700 described above, and in addition, a backlight 800 formed of an organic EL panel equivalent to that described in the above embodiments, or the like, is provided at the rear side of the reflective layer. Since the structure of the backlight 800 is equivalent to that described in the above embodiments, its description is omitted.

In this embodiment, the reflective layer 750 may be a transflective layer equivalent to that described in the above embodiments or may be formed of a color reflective layer provided with an optional color tone. As the color reflective layer, an optional structure may be used which is formed of a color agent, such as a dye or a pigment, appropriately compounded with a material forming the reflective layer, or which is formed of a reflective material provided with a color filter layer on the surface thereof.

For example, when the color tone of the light modulator 72 is black, the reflective layer 750 is a transflective reflective layer similar to that described in the above embodiments. When the structure is formed as shown in FIG. 8, and as is the case described in the above embodiments, the display area of the liquid crystal panel is bright (white) when an electric field is not applied and is dark (black) when an electric field is applied. Accordingly, as shown in FIG. 7, when (four) liquid crystal panels 700 forming a display pattern (i.e. numeral “4” in the figure) are placed in a non-application state of an electric field, and (three) liquid crystal panels 700 which are not part of the desired display pattern are placed in an application state of an electric field, reverse display (display of negative pattern) can be performed by using the surface of the light modulator 72 and the liquid crystal panels 700 in an application state of an electric field as a background.

In this embodiment, as in the second embodiment, a color polarizer may be used so as to obtain a color tone, which is approximately equivalent to the color tone of the surface of the light modulator 72, in the display areas of the liquid crystal panels 700 in an application state of an electric field. In addition, by forming the color layer described above and another light modulator on each liquid crystal panel 700, a two-color display can also be realized, as in the case of the third embodiment.

Furthermore, although one display area is formed by one liquid crystal panel 700 in this embodiment, at least two display areas may be formed by one (common) liquid crystal panel. For example, in the exemplary embodiment of FIG. 8, it is possible that one (common) liquid crystal panel be provided at the rear sides of at least two display windows, and that at least two pixels corresponding to individual display windows 72a be formed in the liquid crystal panel. Alternatively, it may also be possible that a liquid crystal panel having at least two pixels, which are independently controllable, are provided at the rear side of one display window 72aso as to optionally create displays in a plurality of areas in the display window 72a.

When a relatively large display device is formed, this embodiment can realize one display mode using a plurality of simple liquid crystal panels. Accordingly, the liquid crystal display device according to this embodiment can be effectively used in place of an electronic display board, an outdoor display, an advertising tower, a scoreboard, an electric bulletin board, or the like. In the case described above, since the pixel unit of this liquid crystal panel is large, and in addition, the number of the pixels is small, the display device can be manufactured at a low cost.

Other Structures

Constituent elements can be commonly used in the embodiments described above, and the embodiments may be further modified as described below.

First, a schematic structure of a panel driving means suitable for driving a liquid crystal display device, such as describe above, is shown in FIG. 10. As shown in FIG. 10, the liquid crystal display device 52 used in the above embodiments may include a liquid crystal driving circuit 1010 for generating a reverse display as described above, a control circuit 1020 for controlling liquid crystal driving circuit 1010, and an electric power circuit 1030 for supplying electrical power to the liquid crystal driving circuit 1010. In addition, although not shown in the figure, a circuit unit for supplying electric power to the backlight described above and for performing control thereof may be provided inside, or outside, the liquid crystal display device 52.

Liquid crystal driving circuit 1010 is includes a first driving circuit unit 1011 and a second driving circuit 1012. First driving circuit unit 1011 supplies a driving signal Vc to a common electrode (i.e., one electrode from the pair of opposing transparent electrodes described in the above embodiments) of a liquid crystal panel of any of the above embodiments illustratively shown as square 100. Second driving circuit unit 1012 supplies a driving signal Vs to a segment electrode (the other of the two opposing transparent electrodes) of the liquid crystal panel, 100.

Control circuit 1020 receives display data D and control data C from the outside, supplies a control signal S1 to liquid crystal driving circuit 1010, and when necessary, supplies a control signal S2 to electric power circuit 1030. Control signal S1 controls liquid crystal driving circuit 1010 so as to generate driving signals Vc and Vs described above.

The electric power circuit 1030 supplies liquid crystal driving circuit 1010 with a plurality of voltage potentials from a predetermined electric power source. Voltage potentials Ve are necessary for generating driving signals Vc and Vs The liquid crystal driving circuit 1010 changes these voltage potentials Ve into driving signals Vc and Vs in accordance with the control signals S1.

In the embodiment described above, no voltage is applied, or less than a threshold voltage is applied, to a pixel of a conventional, normally white, liquid crystal panel that would normally be driven with at least the threshold voltage to produce a general display (i.e. a positive pattern display). In addition, a reverse display, i.e. a negative pattern display, may be created by changing the conventional signal mode of, for example, the control signals S1 of control circuit 1020 so as to apply at least a threshold voltage to a pixel that would normally not receive a voltage, or receive less than the threshold voltage, when used to produce a general display, i.e. a positive pattern display. Thus, a reverse display (display of negative pattern) can be very easily incorporated as liquid crystal panel 100 while the liquid crystal driving circuit 1010 maintains a conventional structure.

In addition, without changing the inside structure of the liquid crystal display device shown in FIG. 10 from the conventional structure at all, reverse driving may be performed by making data, such as control data C shown in the figure, which is supplied from the outside, different from that used for general driving.

Next, modified examples of the liquid crystal display device and the electronic apparatus of the above embodiments will be described. In the above embodiments, a transfiective liquid crystal display device is used. However, the same display mode as described above can be obtained by a simple reflective liquid crystal display device or a transmissive liquid crystal display device, and thereby the same advantages as described above can also be obtained. Furthermore, the present invention can be applied to a known front light liquid crystal display device. In the above embodiments, although a transflective layer is used in order to form a transflective liquid crystal display device, a reflective layer having a light transmission portion such as a slit in each pixel may also be used.

In addition, in the above embodiments, polarization means is used which transmits a predetermined polarization component and absorbs another polarization component. However, in an alternate approach, a so-called reflective polarizer which transmits a predetermined polarization component and reflects another polarization component may be used. In the case described above, a reflective color polarizer corresponding to the color polarizer described above may also beused.

Advantages

As has thus been described, according to the present invention, a liquid crystal display device which can perform reverse display (negative pattern) can be formed, the production cost thereof can be reduced, and the display quality thereof can be improved.

While the invention has been described in conjunction with several specific embodiments, it is evident to those skilled in the art that many further alternatives, modifications and variations will be apparent in light of the foregoing description. Thus, the invention described herein is intended to embrace all such alternatives, modifications, applications and variations as may fall within the spirit and scope of the appended claims.

What is claimed is:

1. A liquid crystal display device comprising:
a liquid crystal panel having a pixel; and
a light modulation means including a first area provided with a predetermined light modulation property at a position approximately corresponding to said pixel, and including a second area provided with a light modulation property at a position other than that of said first area;
wherein the light modulation property of said second area is different from the light modulation property of said first area.

2. The liquid crystal display device of claim 1, wherein said second area does not overlap any area occupied by said pixel.

3. The liquid crystal display device of claim 1, wherein said liquid crystal panel is effective for selectively displaying in said pixel one of a first viewing mode and a second viewing mode in accordance with a voltage application state at said pixel by using light which is modulated in said first area, wherein said first viewing mode is different from said second viewing mode.

4. The liquid crystal display device of claim 3, wherein said first viewing mode is visually nearer to a third viewing mode which is obtained by using light modulated in said second area, and said second viewing mode is visually further from said third viewing mode.

5. The liquid crystal display device of claim 4, wherein said liquid crystal panel is formed so that said second viewing mode is displayed in said pixel when a voltage is not applied to said pixel.

6. The liquid crystal display device of claim 4, wherein said second viewing mode has high luminosity as compared to that of said first viewing mode.

7. The liquid crystal display device of claim 4, wherein said pixel is one of a plurality of pixels and said second viewing mode is one of a plurality of different second viewing modes each associated with a respective one of said plurality of pixels.

8. The liquid crystal display device of claim 4, wherein said second viewing mode includes a plurality of alternate viewing modes, each different from each other and associated with said pixel.

9. The liquid crystal display device of claim 1, wherein said liquid crystal panel includes:
a liquid crystal cell which exhibits a retardation property dependent on an applied electric field;
a first polarization means provided at the front side of said liquid crystal cell; and
a second polarization means provided at the rear side of the liquid crystal cell.

10. The liquid crystal display device of claim 9, wherein said light modulation means is disposed at the rear side of said second polarization means and adjacent thereto.

11. The liquid crystal display device of claim 9, wherein said light modulation means is disposed at the front side of said first polarization means.

12. The liquid crystal display device of claim 9, wherein at least one of said first polarization means and said second polarization means selectively modulates a polarization component having a transmission plane in a predetermined direction to form a predetermined polarized spectral distribution of said polarization component so that a color tone obtained by said polarized spectral distribution and a modulated spectral distribution formed by light modulation in the first area is approximately equivalent to a color tone obtained by light modulated in the second area.

13. The liquid crystal display device of claim 3, wherein said liquid crystal panel includes:
a liquid crystal cell;
a first polarization means provided at the front side of said liquid crystal cell; and
a second polarization means provided at the rear side of said liquid crystal cell;
wherein at least one of said first polarization means and said second polarization means selectively modulates a polarization component having a transmission plane in a predetermined direction to form a predetermined polarized spectral distribution of the polarization component so as to display the first viewing mode by the polarized spectral distribution and a modulated spectral distribution formed by light modulation in said first area.

14. The liquid crystal display device of claim 13, wherein said second viewing mode is displayed in said pixel by light modulation in said first area without being modulated by at least one of said first polarization means and said second polarization means which are able to form the polarized spectral distribution.

15. The liquid crystal display device of claim 1, wherein a plurality of said liquid crystal panels each having a respective one of said pixel, and said light modulation means is provided at the front side of said plurality of said liquid crystal panels.

16. An electronic apparatus comprising a liquid crystal display device according to claim 1.

17. An electronic apparatus according to claim 15, wherein a liquid crystal display surface of said liquid crystal display device is used as a time information display portion.
